(19) United States
(12) Patent Application Publication
(10) Pub. No.: US 2012/0135159 A1
(43) Pub. Date: May 31, 2012

(54) SYSTEM AND METHOD FOR IMPRINT-GUIDED BLOCK COPOLYMER NANO-PATTERNING

(75) Inventors: Shuaigang Xiao, Fremont, CA (US); Renè Johannes Marinus Van De Veerdonk, Pleasanton, CA (US); Kim Yang Lee, Fremont, CA (US); David Kuo, Palo Alto, CA (US); XiaoMin Yang, Livermore, CA (US); Wei Hu, Chandler, AZ (US)

(73) Assignee: Seagate Technology LLC, Scotts Valley, CA (US)

(21) Appl. No.: 12/957,196

(22) Filed: Nov. 30, 2010

(51) Int. Cl. B05D 5/00; B05D 3/06; B05C 9/10; B05C 9/14; B05C 9/12; B05D 3/12; B05D 3/00

(52) U.S. Cl. 427/534; 427/282; 427/595; 427/553; 427/535; 118/600

(57) ABSTRACT

This disclosure describes a method for nano-patterning by incorporating one or more block copolymers and one or more nano-imprinting steps in the fabrication process. The block copolymers may be comprised of organic or organic components, and may be lamellar, spherical or cylindrical. As a result, a patterned medium may be formed having one-dimensional or two-dimensional patterns with a feature pitch of 5-100 nm and/or a bit density of at least 1 Tdpsi.

### FIELD

This disclosure relates generally to patterned media, and specifically, to the use of block copolymers for nano-imprint lithographic (“NIL”) patterning of bit patterned media.

### BACKGROUND

Bit patterned media (“BPM”) is used in the storage industry because of its high storage capacity. The storage capacity of BPM is dependent upon the density of the magnetic islands, or “bits” on the media substrate surface.

Current processes for achieving high density patterned media include electron beam (e-beam) direct writing techniques for imprint mold fabrication, nano-imprinting and pattern transfer into magnetic dots. Directed self-assembly combining ‘top-down’ e-beam lithography and ‘bottom-up’ self-assembling materials like block copolymers have been accepted as extendable techniques to generate ultra-high density nano-patterns for imprint mold fabrication. In this approach, e-beam lithography is conventionally used to chemically or topographically pattern a surface.

### BRIEF DESCRIPTION OF THE FIGURES

Embodiments of this disclosure are illustrated by way of example and not limitation in the figures of the accompanying drawings, in which like references indicate similar elements, and in which:

FIG. 1 is an SEM image illustrating block copolymer nano-patterning using an e-beam lithography fabricated pre-pattern.

FIG. 2 is a flow diagram, according to an embodiment.

FIG. 3 is a flow diagram, according to an embodiment.

FIG. 4 is a flow diagram, according to an embodiment.

FIG. 5 is a flow diagram, according to an embodiment.

FIG. 6 is a flow diagram, according to an embodiment.

FIG. 7 is a flow diagram, according to an embodiment.

FIG. 8 is a SEM image, according to an embodiment.

FIG. 9 is an SEM image, according to an embodiment.

FIG. 10 is an SEM image, according to an embodiment.

### DETAILED DESCRIPTION

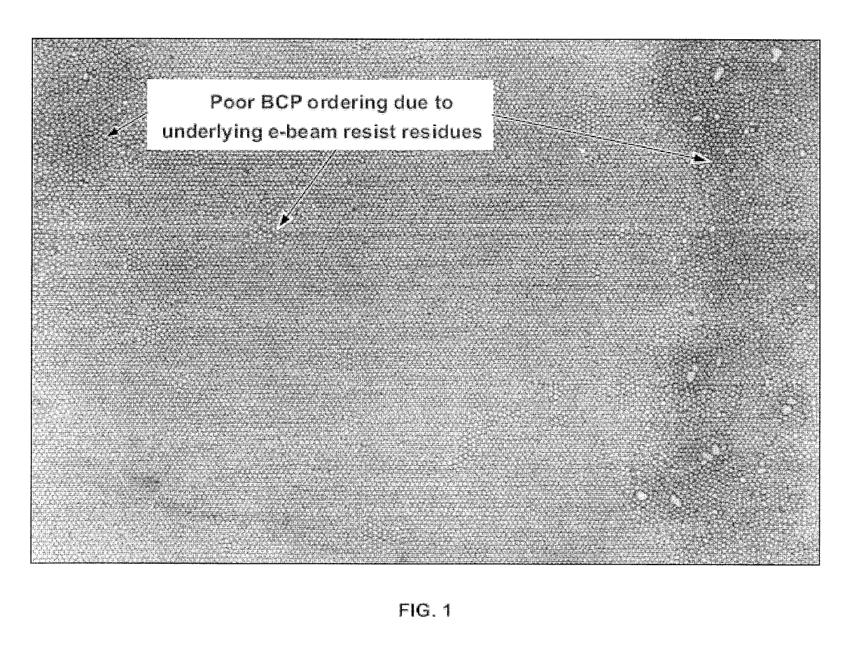

Disclosed herein are a system and processes for incorporating guided growth of BCPs in a BPM manufacturing process. Specifically, the processes described herein illustrate how BCPs may be used to form nano-patterns on a media substrate without a pre-pattern formed on the substrate by e-beam lithography. This disclosure describes processes other than the fabrication of a pre-pattern made by e-beam lithography. E-beam lithography on the substrate may introduce contamination defects into the pre-pattern that affects, in turn, the long-range ordering and quality of the growth of block copolymer (BCP) high density structures. FIG. 1 is a scanning electron microscope image of a high density BCP pattern produced starting with a lower density pre-pattern formed on the substrate using e-beam lithography. Uniform periodicity of the high density pattern is not maintained across the entire substrate.

Instead, an imprint technique is used to guide the growth of BCP structures. As a result, embodiments of this disclosure may avoid the pattern defects and potential chemo-toxicity associated with e-beam lithography techniques. One having ordinary skill in the art will appreciate that different BCPs may be used, such as a cylindrical, lamellar or spherical BCP. In an embodiment, the BCP may have organic components, inorganic components, or a combination of organic and inorganic components. BCP selection may be based upon the size, molecular weight, or other features of the BCP constituent units that are described further below. While specific BCPs are selected for the particular application, the process disclosed herein is a generalized process. Other variations are discussed further below and are illustrated in the figures.

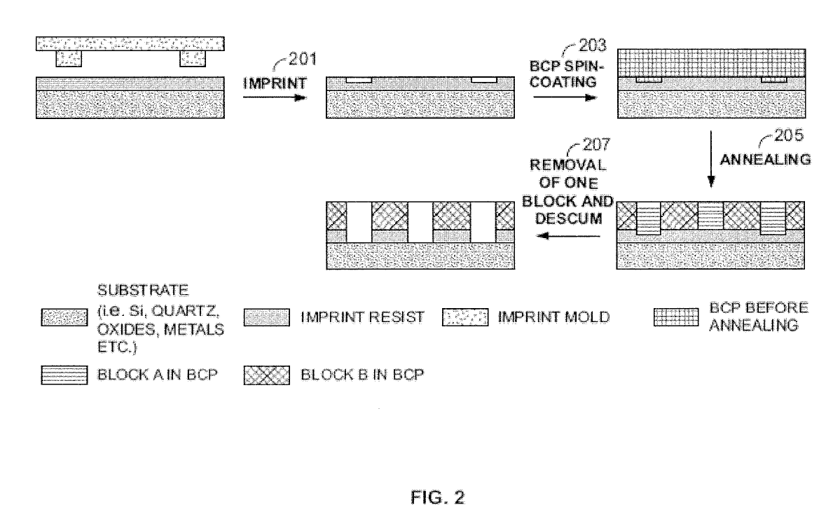

FIGS. 2-7 are directed to various embodiments of this disclosure; however, one of ordinary skill in the art will appreciate that other embodiments are possible without departing from this disclosure, and that the processes depicted in FIGS. 2-7 are not intended to limit this disclosure to any one process or embodiment. A person having ordinary skill in the art will appreciate that FIGS. 2-7 illustrate merely a portion of the BPM manufacturing process, and that other processes may be involved before or after the processes shown in FIGS. 2-7 and described above. For example, FIGS. 2-7 illustrate embodiments of processes for generating a BPM template used in subsequent processes for manufacturing. Alternatively or additionally, FIGS. 2-7 illustrate embodiments of processes for directly patterning BPM substrates using BCPs.

In the following examples, the BCP is comprised of at least two constituent units, structural units or “blocks”, herein termed “block A” and “block B”, or “A block” and “B block”. The following examples describe removal of the A block; however, a person having ordinary skill in the art will appreciate that in an embodiment, the B block may be removed instead of the A block. Use of the singular “block A” or “block B” also includes use of plural “blocks A” and “blocks B.” As described above, block A and block B may be organic or inorganic, or block A may be organic, and block B inorganic, or block A may be inorganic and block B organic. In an embodiment, block A or block B comprises an organic polystyrene-block-polymethylmethacrylate (PS-b-PMMA), polystyrene-block-poly2-vinylpyridine, polystyrene-block-poly4-vinylpyridine, polystyrene-block-polyethyleneoxide, polystyrene-block-polyisoprene or polystyrene-block-butadiene. In an embodiment, block A or block B comprises an inorganic polystyrene-block-polydimethylsiloxane (PS-b-PDMS) or polystyrene-block-polyferrocenylsilane. A person having ordinary skill in the art will appreciate that the processes described herein may be varied accordingly depending upon the chemical characteristics of the BCP blocks. One will appreciate that selection of the BCP may also depend upon the target pattern to be created using the BCP. For example, the topographical pattern left by the imprinting steps described below may determine the chosen BCP, since certain BCP blocks may correlate better with certain topographical pattern features and pattern dimensions.

FIG. 2 is directed to a process in which a cylindrical or lamellar BCP is used with an imprinted resist pattern. In an embodiment, the BCP used in FIG. 2 is a PS-b-PMMA; however, other cylindrical or lamellar BCPs may be used as well. In block 201, an imprint resist overlaying a substrate is imprinted with an imprint mold to form a topographic pattern. Imprinting may utilize UV, thermal or inking techniques. In block 203, a BCP is spin-coated onto the imprinted resist, then annealed in block 205. A person having skill in the art will appreciate that thermal or solvent annealing may be applied in block 205. In block 207, one of the blocks of the annealed BCP is selectively removed. In an embodiment, if block A and block B are organic, then UV exposure and an acid is used to remove block A. For example, if the BCP used in block 203 is PS-b-PMMA, then UV exposure and an acetic wash or solvent is used to remove the PMMA block. In an embodiment, if block A is organic and B is inorganic, then oxygen plasma is used to remove the organic A block. Block 207 of FIG. 2 also includes descumming that may include oxygen plasma etching; however, other methods to descum the annealed BCP may also be used in order to remove residue.

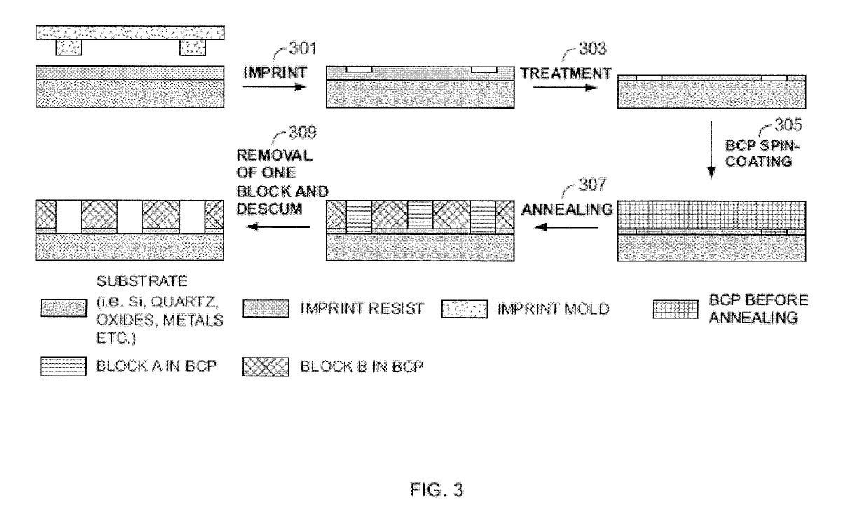

A process in which a cylindrical or lamellar BCP is used with an imprinted and treated resist pattern is shown in FIG. 3. In an embodiment, the BCP used in FIG. 3 is a PS-b-PMMA; however, other cylindrical or lamellar BCPs may be used as well. In block 301, an imprint resist overlaying a substrate is imprinted with an imprint mold to form a topographic pattern. Imprinting may utilize UV, thermal or inking techniques. In block 303, the imprinted resist is chemically treated in order to form a chemical pattern. In block 305, a BCP is spin-coated onto the imprinted treated resist, then annealed in block 307. A person having skill in the art will appreciate that thermal or solvent annealing may be applied in block 307. In block 309, one of the blocks formed from the annealed BCP is selectively removed. In an embodiment, if block A and block B are organic, then UV exposure and an acid or solvent is used to remove block A. For example, if the BCP used in block 305 is PS-b-PMMA, then UV exposure and an acetic wash is used to remove the PMMA block. In an embodiment, if block A is organic and B is inorganic, then oxygen plasma is used to remove the organic A block. Block 309 of FIG. 3 also includes descumming that may include oxygen plasma etching; however, other methods to descum the annealed BCP may also be used in order to remove residue.

By way of example, the following describes one process that incorporates the process illustrated in FIG. 3. In block 301, the imprint resist overlaying the substrate is a 20-50 nm thick thin film of an acrylate-based UV imprint resist. Even though an acrylate-based UV imprint resist was used in this example, other kinds of imprint resist materials could also be used as long as they have affinity to one block in the copolymer. Other imprint methods, such as thermal imprint or inking may also be applied. In this example, a pre-fabricated imprint mold was used to create a topographic surface pattern in the resist layer. In block 303, the imprinted resist was treated using an oxygen plasma process at 30 W, 2 mTorr of pressure, and a O₂ flow rate of 30 standard cubic centimeters per minute (sccm). As a result, the imprinted resist layer was thinned down to less than 10 nm thick, exposing the substrate in the imprint areas. The thinned imprint resist layer is then cleaned to remove residue, particularly in the depressions or holes made by the imprint.

In block 305, a BCP coating of PS-b-PMMA in 1% toluene solution was spin coated onto the imprint-defined patterned substrate. This is followed by block 307, in which the PS-b-PMMA films are annealed at 170° C. for 12-24 hours to enable guided self-assembly formation of the ordered BCP nano-patterns (i.e., a thermal annealing process). One having ordinary skill in the art will appreciate that a solvent annealing process using acetone vapor atmosphere may also be used. Selective polymer block removal in block 309 is accomplished using UV radiation set at 248 nm. For example, this degrades the PMMA blocks while cross-linking the polystyrene (PS) blocks. After soaking in acetic acid for one minute to remove any impurities, residue or portions of the degraded BCP, a nano-porous PS cylindrical system template or a PS line array is left. Whether the remaining PS forms a cylindrical system or line/lamellar array is determined by the particular BCP selected in block 305 above.

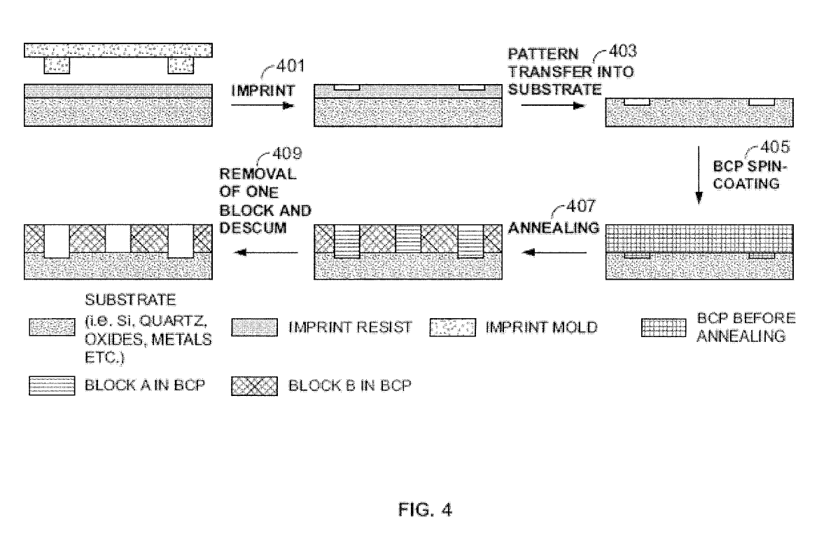

FIG. 4 is directed to a process in which a cylindrical or lamellar BCP is used with an imprinted and transferred pattern. In an embodiment, the BCP used in FIG. 4 is a PS-b-PMMA; however, other cylindrical or lamellar BCPs may be used as well. In block 401, an imprint resist overlaying a substrate is imprinted with an imprint mold to form a topographic pattern. Imprinting may utilize UV, thermal or inking techniques. In block 403, the imprinted resist pattern is transferred onto a substrate. In block 405, a BCP is spin-coated onto the imprinted treated resist, then annealed in block 407. A person having skill in the art will appreciate that thermal or solvent annealing may be applied in block 407. In block 409, one of the blocks from the annealed BCP is selectively removed. In an embodiment, if block A and block B are organic, then UV exposure and an acid or solvent is used to remove block A. For example, if the BCP used in block 405 is PS-b-PMMA, then UV exposure and an acetic wash is used to remove the PMMA block. In an embodiment, if block A is organic and B is inorganic, then oxygen plasma is used to remove the organic A block. Block 409 of FIG. 4 also includes descumming that may include oxygen plasma etching; however, other methods to descum the annealed BCP may also be used in order to remove residue.

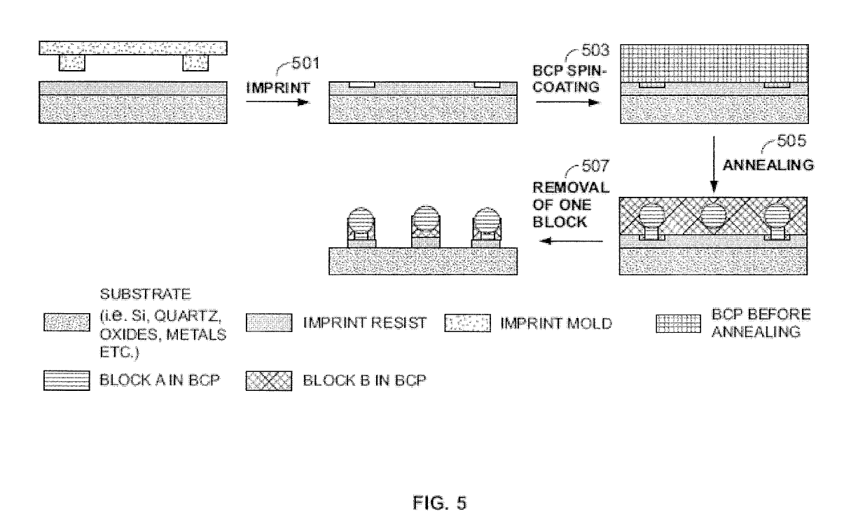

A process in which a spherical BCP is used with an imprinted resist pattern is shown in FIG. 5. In an embodiment, the BCP used in FIG. 5 is a PS-b-PDMS; however, other spherical BCPs may be used as well. In block 501, an imprint resist overlaying a substrate is imprinted with an imprint mold to form a topographic pattern. Imprinting may utilize UV, thermal or inking techniques. In block 503, a BCP is spin-coated onto the imprinted resist, then annealed in block 505. A person having skill in the art will appreciate that thermal or solvent annealing may be applied in block 505 to grow self-assembled BCP structures. In block 507, one of the blocks from the annealed BCP is selectively removed. In an embodiment, if block A is inorganic, but block B is organic, then oxygen plasma is used to remove block B. For example, if the BCP used in block 503 is PS-b-PDMS, then oxygen plasma may be used to remove the PS block, thereby leaving a nano-dot array.

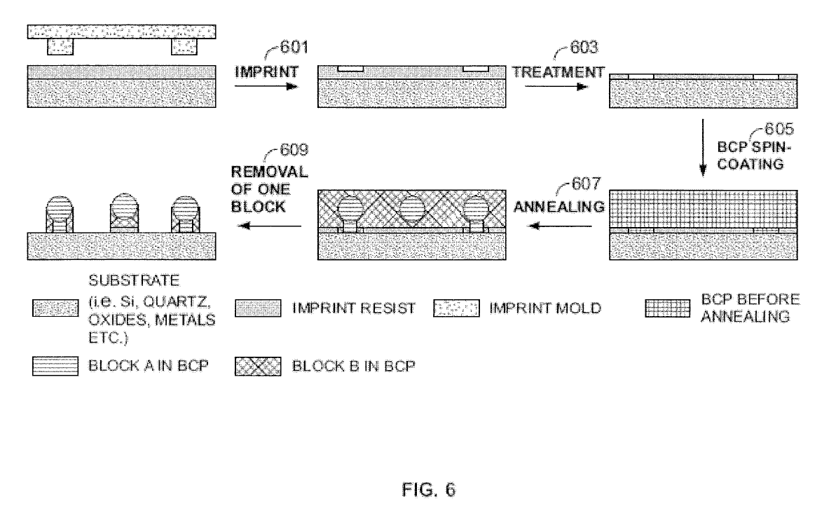

A process in which a spherical BCP is used with an imprinted and treated resist pattern is shown in FIG. 6. In an embodiment, the BCP used in FIG. 6 is a PS-b-PDMS; however, other spherical BCPs may be used as well. In block 601, an imprint resist overlaying a substrate is imprinted with an imprint mold to form a topographic pattern. Imprinting may utilize UV, thermal or inking techniques. In block 603, the imprinted resist is chemically treated in order to form a chemical pattern. In block 605, a BCP is spin-coated onto the imprinted treated resist, then annealed in block 607. A person having skill in the art will appreciate that thermal or solvent annealing may be applied in block 607. In block 609, one of the blocks from the annealed BCP is selectively removed. In an embodiment, if block A is inorganic, but block B is organic, then oxygen plasma is used to remove block B. For example, if the BCP used in block 605 is PS-b-PDMS, then oxygen plasma is used to remove the PS block, thereby leaving a nano-dot array.

By way of example, the following describes one process that incorporates the process illustrated in FIG. 6. In block 601, the imprint resist overlaying the substrate is a 20-50 nm thick thin film of an acrylate-based UV imprint resist. Even though an acrylate-based UV imprint resist was used in this example, other kinds of imprint resist materials may also be used as long as they have affinity to one block in the copolymer. Other imprint methods, such as thermal imprint or inking may also be applied. In this example, a pre-fabricated imprint mold was used to create a topographic surface pattern in the resist layer. In block 603, the imprinted resist was treated using an oxygen plasma process at 30 W, 2 mTorr of pressure, and a O₂ flow rate of 30 sccm. As a result, the imprinted resist layer thinned to a thickness less than 10 nm. The thinned imprint resist layer is then cleaned to remove residue, particularly in the depressions or holes made by the imprint.

In block 605, a BCP coating of PS-b-PDMS in 1% toluene solution was spin coated onto the imprint-defined patterned substrate. This step is followed by block 607, in which the PS-b-PDMS films are annealed at 170° C. for 12-24 hours to enable self-assembly of the ordered BCP nano-patterns (i.e, a thermal annealing process). One having ordinary skill in the art will appreciate that a solvent annealing process using toluene vapor atmosphere may also be used. Selective block removal in block 609 is accomplished using an oxygen plasma process at 30 W, 2 mTorr of pressure, and an O₂ flow rate of 30 seem. This step removes most of the PS blocks, thereby leaving behind a PDMS nanodot array. One will appreciate that selection of a BCP of certain molecular weights and volume ratios between blocks will determine the spherical morphology, domain sizes and spacing of the nano-dot array.

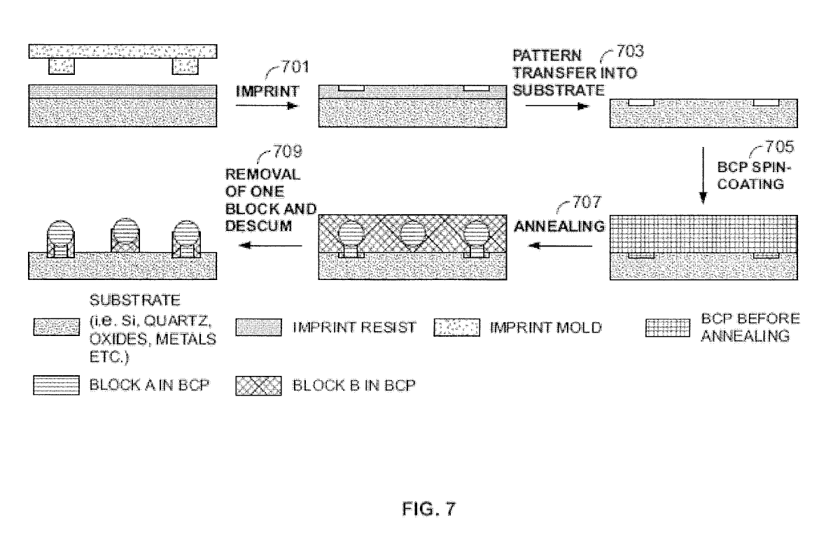

A process in which a spherical BCP is used with an imprinted and transferred pattern is shown in FIG. 7. In an embodiment, the BCP used in FIG. 7 is a PS-b-PDMS; however, other spherical BCPs may be used as well. In block 701, an imprint resist overlaying a substrate is imprinted with an imprint mold to form a topographic pattern. Imprinting may utilize UV, thermal or inking techniques. In block 703, the imprinted resist pattern is transferred onto a substrate. In block 705, a BCP is spin-coated onto the imprinted treated resist, then annealed in block 707. A person having skill in the art will appreciate that thermal or solvent annealing may be applied in block 707. In block 709, one of the blocks from the annealed BCP is selectively removed. In an embodiment, if block A is inorganic, but block B is organic, then oxygen plasma is used to remove block B. For example, if the BCP used in block 705 is PS-b-PDMS, then oxygen plasma is used to remove the PS block, thereby leaving a nano-dot array.

By way of example, the following describes one process that incorporates the process illustrated in FIG. 7. In block 701, the imprint resist overlaying the substrate is a 20-50 nm thick thin film of an acrylate-based UV imprint resist. Even though an acrylate-based UV imprint resist was used in this example, other kinds of imprint resist materials could also be used as long as they have affinity to one block in the copolymer. Other imprint methods, such as thermal imprint or inking may also be applied. In this example, a pre-fabricated imprint mold was used to create a topographic surface pattern in the resist layer. The imprinted resist was then treated using an oxygen plasma process at 30 W, 2 mTorr of pressure, and a O₂ flow rate of 30 sccm, then cleaned to remove residue, particularly in the depressions or holes made by the imprint

In block 703, a CF₄ reactive-ion etch at 80 W, 20 mTorr, 30 sccm CF₄ and 30 sccm Ar was used to transfer the imprinted resist pattern into an underlying silicon substrate. The etch depth was 5-10 nm. In block 705, a BCP coating of PS-b-PDMS in 1% toluene solution was spin coated onto the patterned substrate, then annealed in block 707, at 170° C. for 12-24 hours to enable self-assembly of the ordered BCP nano-patterns (i.e, a thermal annealing process). One having ordinary skill in the art will appreciate that a solvent annealing process using toluene vapor atmosphere may also be used. Selective block removal in block 709 was accomplished using an oxygen plasma process at 30 W, 2 mTorr of pressure, and an O₂ flow rate of 30 sccm. This removes most of the PS blocks, thereby leaving behind a PDMS nanodot array. One will appreciate that selection of a BCP of certain molecular weights and volume ratios between blocks will determine the spherical morphology; domain size and spacing of the nano-dot array.

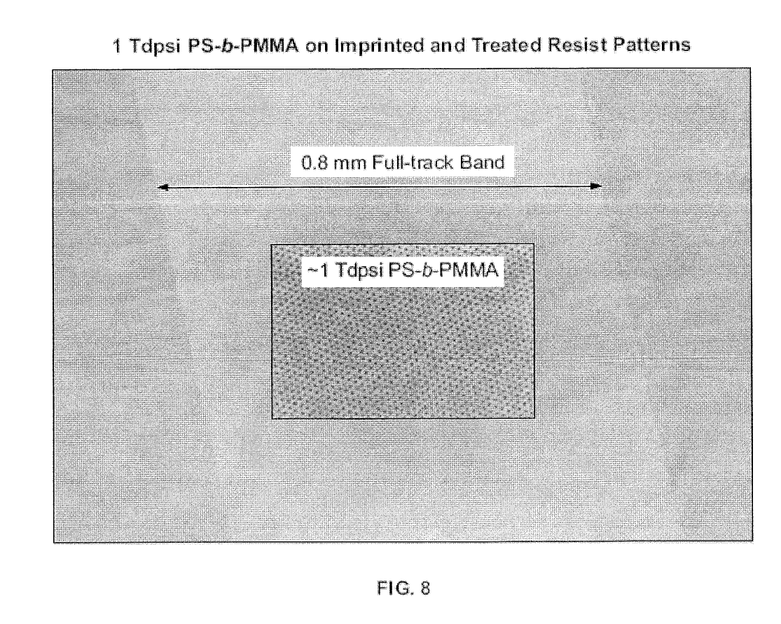

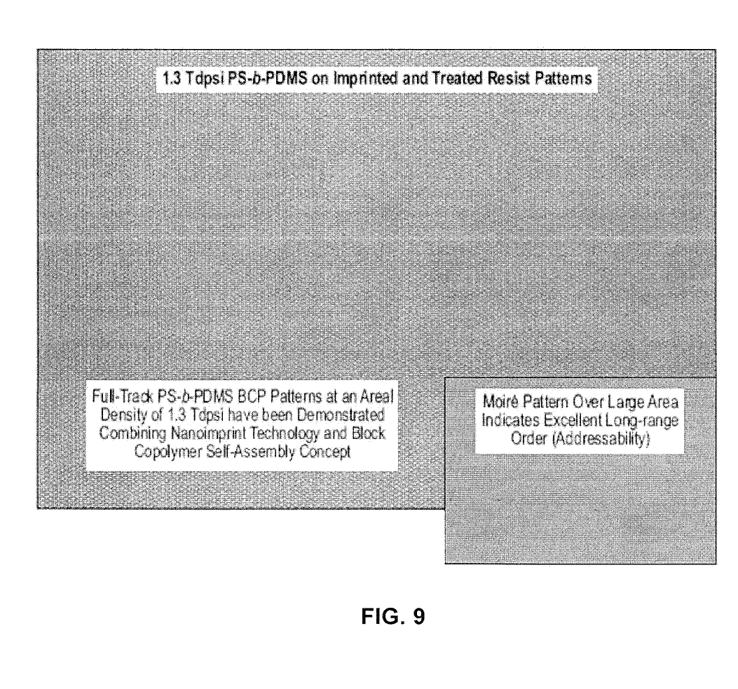

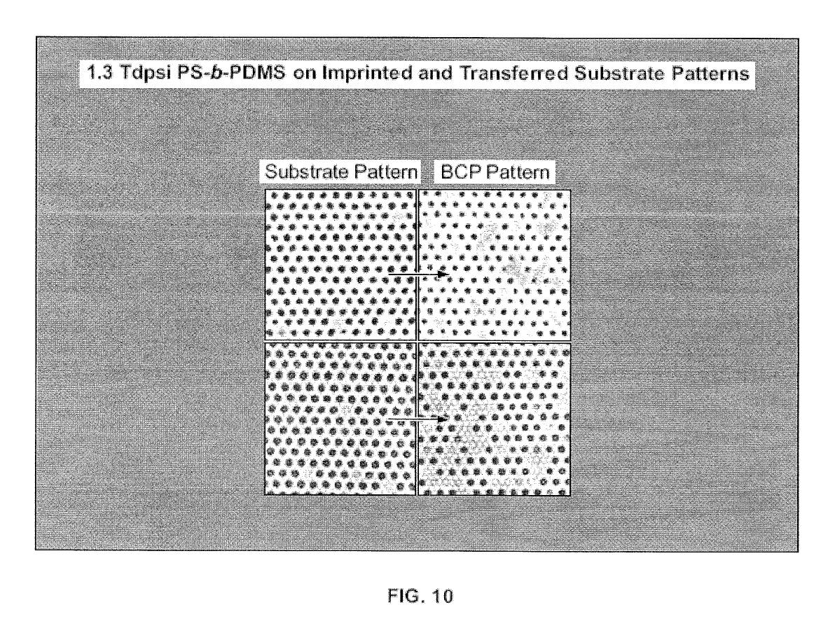

As mentioned above and illustrated in FIG. 1, defect-free long-range lateral ordering over a large area is not currently found in patterned templates or substrates formed by e-beam lithography plus block copolymer self-assembly due to the chemicals and processes used during the pre-patterning process. Such defects may be avoided using the processes described herein because e-beam lithography is eliminated from the pre-patterning process and substituted with UV, thermal or inking imprinting techniques. A person having ordinary skill in the art will appreciate that directing the self-assembly of BCP as described herein may result in an imprint template having a linear or areal bit density of at least 1 Tdpsi, and/or a feature pitch of 5-100 nm. Moreover, the processes described herein form long-range laterally ordered arrays that enable scalable nano-patterning. FIGS. 8-10 are scanning electron microscope (“SEM”) images of BCP templates produced by embodiments of the processes described above and illustrated in FIGS. 2-7. FIG. 8 illustrates an embodiment in which a PS-b-PMMA BCP template has a bit density of 1 Tdpsi. The surface pre-pattern has been imprinted and treated as described in FIG. 3. FIG. 9, illustrates an example in which a PS-b-PDMS BCP template has a bit density of 1.3 Tdpsi. The surface pre-pattern has been imprinted and treated. As FIG. 9 shows, the lateral ordering differs from the lateral ordering shown in FIG. 1. The formed Moiré pattern over the large area shown in FIG. 9 indicates the long-range scalability of this disclosure. FIG. 10 illustrates an example in which a PS-b-PDMS BCP template has a bit density of 1.3 Tdpsi. In FIG. 10, the surface pre-pattern has been imprinted and transferred as described in FIG. 7.

As previously mentioned, the processes illustrated in FIGS. 2-7 and described herein may form part of a bit-patterned media (BPM) media fabrication process. In an embodiment, this disclosure may be applied to any fabrication process featuring large-area high-density nano-patterning with long-range lateral ordering, such as patterning magnetic film layers in storage media, semiconductor production, and the like. In an embodiment, the processes described herein may be used to fabricate a template for use as a mask, thereby facilitating the deposition of functional materials or other additive processes. In an embodiment, the processes described herein may be used to facilitate the etching of functional materials, to directly or indirectly form a pattern on storage media, or other subtractive processes. Other applications are possible without departing from the scope of this disclosure.

It will be evident to one of ordinary skill in the art, that an embodiment may be practiced without these disclosed specific details. In other instances, well-known structures and devices are shown in block diagram form to facilitate explanation. The description of the embodiments is not intended to limit the scope of the claims appended hereto. Further, in the methods disclosed herein, various processes are disclosed illustrating some of the functions of an embodiment. One will appreciate that these processes are merely examples and are not meant to be limiting in any way. Other functions may be contemplated without departing from this disclosure or the scope of an embodiment.

What is claimed is:

1. A method comprising:
imprinting a resist on a substrate with an imprint mold to form a topographic surface pattern on the resulting imprinted resist;
depositing a block copolymer (“BCP”) material on at least a portion of the resulting imprinted resist, wherein the BCP material correlates to the topographic surface pattern on the resulting imprinted resist;
annealing the deposited BCP material to form an annealed BCP; and,
removing at least a portion of the annealed BCP, wherein a pattern on the substrate having discrete domains is capable of being formed.

2. The method of claim 1, further comprising the step of:
treating the resulting imprinted resist to form a chemical surface pattern prior to depositing the BCP material.

3. The method of claim 2, wherein treating includes exposing the resulting imprinted resist to oxygen plasma.

4. The method of claim 1, further comprising:
transferring the resulting imprinted pattern directly onto the substrate prior to depositing the BCP material.

5. The method of claim 1, wherein imprinting includes applying an imprinting process selected from the group of processes consisting of UV imprinting, thermal imprinting and inking imprinting.

6. The method of claim 1, wherein depositing includes depositing a BCP material selected from the group of BCP materials consisting of a lamellar block copolymer, a cylindrical block copolymer and a spherical block copolymer.

7. The method of claim 1, wherein the BCP material is selected from the group of BCP materials consisting of polystyrene-block-polymethylmethacrylate (PS-b-PMMA), polystyrene-block-poly2-vinylpyridine, polystyrene-block-poly4-vinylpyridine, polystyrene-block-polyethyleneoxide, polystyrene-block-polyisoprene, polystyrene-block-butadiene, and mixtures thereof.

8. The method of claim 1, wherein the BCP material is selected from the group of BCP materials consisting of polystyrene-block-polydimethylsiloxane (PS-b-PDMS), polystyrene-block-polyferrocenylsilane, and mixtures thereof.

9. The method of claim 1, wherein annealing includes thermal annealing.

10. The method of claim 1, wherein annealing includes solvent annealing.

11. The method of claim 1, wherein removing includes exposing the resist to UV radiation and at least one acid.

12. The method of claim 1, wherein removing includes exposing the resist to at least one solvent.

13. The method of claim 1, wherein removing includes exposing the resist to oxygen plasma.

14. The method of claim 1, wherein the pattern formed in removing at least a portion of the annealed BCP has a feature pitch of 5-100 nm.

15. The method of claim 1, wherein the pattern formed in removing at least a portion of the annealed BCP has a long-ranged laterally ordered 1D array.

16. The method of claim 1, wherein the pattern formed in removing at east a portion of the annealed BCP has a long-ranged laterally ordered 2D array.

17. A method comprising:
imprinting a resist on a substrate with an imprint mold to form a topographic surface pattern on the resulting imprinted resist;
depositing a block copolymer (“BCP”) material on at least a portion of the resulting imprinted resist, wherein the BCP material correlates to the topographic surface pattern on the resulting imprinted resist;
annealing the deposited BCP material to form an annealed BCP;
removing at least a portion of the annealed BCP wherein a template having discrete domains is capable of being formed; and
using the template to pattern a resist on a substrate to form a pattern on the substrate.

18. The method of claim 17, wherein the pattern formed in step removing at least a portion of the annealed BCP has a feature pitch of 5-100 nm.

19. A method comprising:
imprinting a resist on a substrate with an imprint mold to form a topographic surface pattern on the resulting imprinted resist;
depositing a block copolymer (“BCP”) material on at least a portion of the resulting imprinted resist, wherein the BCP material correlates to the topographic surface pattern on the resulting imprinted resist;
annealing the deposited BCP material to form an annealed BCP;
removing at least a portion of the annealed BCP, wherein a template having discrete domains is capable of being formed; and,
using the template as a mask.

20. The method of claim 19, wherein removing at least a portion of the annealed BCP results in a template having a feature pitch of 5-100 nm.

21. A system comprising:
an imprint mold for imprinting a resist on a substrate to form a topographic surface pattern on the resulting imprinted resist;
a deposition apparatus for depositing a block copolymer (“BCP”) material on at least a portion of the resulting imprinted resist, wherein the BCP material correlates to the topographic surface pattern on the resulting imprinted resist;
an annealing apparatus for annealing the deposited BCP material to form an annealed BCP; and
a BCP removal apparatus for removing at least a portion of the annealed BCP, wherein a template having discrete domains having a feature pitch of 5-100 nm capable of being formed.

22. A system comprising:
a means for imprinting a resist on a substrate to form a topographic surface pattern on the resulting imprinted resist;
a means for depositing a block copolymer (“BCP”) material on at least a portion of the resulting imprinted resist, wherein the BCP material correlates to the topographic surface pattern on the resulting imprinted resist;
a means for annealing the deposited BCP material to form an annealed BCP; and
a means for removing at least a portion of the annealed BCP, wherein a template having discrete domains having a feature pitch of 5-100 nm capable of being formed.
